(19) United States
(12) Patent Application Publication
(10) Pub. No.: US 2013/0016835 A1
(43) Pub. Date: Jan. 17, 2013

(54) APPARATUS AND METHOD FOR DISTRIBUTING A STRING OF SECRET BITS OVER A QUANTUM CHANNEL

(71) Applicants: Hugo ZBINDEN, Geneve (CH); Nino WALENTA, Geneve (CH); Charles Ci Wen LIM, Geneve (CH)

(72) Inventors: Hugo ZBINDEN, Geneve (CH); Nino WALENTA, Geneve (CH); Charles Ci Wen LIM, Geneve (CH)

(73) Assignee: UNIVERSITE DE GENEVE, Geneve 4 (CH)

(21) Appl. No.: 13/182,311

(22) Filed: Jul. 13, 2011

(51) Int. Cl. H04K 1/00

(52) U.S. Cl. 380/255

(57) ABSTRACT

For distributing a sequence of symbols, an emitter station transmits to a receiver station quantum systems through a quantum channel. Each of the quantum systems belongs to a set of at least two non-orthogonal quantum states and comprises a group of at least two weak coherent states of an electromagnetic field. Each weak coherent state is in a time bin of duration t. Centers of neighboring weak coherent states in a group are separated by a time T1, with T1 greater than t. Centers of neighboring weak coherent states in adjacent quantum systems are separated by a time T2, with T2 greater than t. In addition, any two weak coherent states separated by T1+T2 are phase coherent. The receiver station comprises an optical subsystem configured to check, for received quantum systems, phase coherence of two weak coherent states of time bins separated by T1+T2.

### FIELD OF THE INVENTION

The present invention relates generally to the field of quantum cryptography, and more particularly to an apparatus and a method enabling two users to exchange a sequence of symbols via a quantum channel. Specifically, the present invention relates to a system and a method for distributing a sequence of secret bits between an emitter station and a receiver station connected by a quantum channel and assessing the maximum amount of information an eavesdropper could have obtained on the sequence.

### BACKGROUND OF THE INVENTION

If two users possess shared random secret information (below the “key”), they can achieve, with provable security, two of the goals of cryptography: 1) making their messages unintelligible to an eavesdropper and 2) distinguishing legitimate messages from forged or altered ones. A one-time pad cryptographic algorithm achieves the first goal, while Wegman-Carter authentication achieves the second one. Unfortunately both of these cryptographic schemes consume key material and render it unfit for use. It is, thus, necessary for the two parties wishing to protect the messages they exchange with either or both of these cryptographic techniques to devise a way to exchange fresh key material. The first possibility is for one party to generate the key and to inscribe it on a physical medium (e.g. a disc, CD-ROM, or ROM) before passing it to the second party. The problem with this approach is that the security of the key depends on the fact that it has been protected during its entire lifetime, from its generation to its use, until it is finally discarded. In addition, it is unpractical and very tedious.

Because of these difficulties, in many applications one resorts instead to purely mathematical methods allowing two parties to agree on a shared secret over an insecure communication channel. Unfortunately, all such mathematical methods for key agreement rest upon unproven assumptions, such as the difficulty of factoring large integers. Their security is, thus, only conditional and questionable. Future mathematical developments may prove them totally insecure.

Quantum cryptography (QC) is a method allowing the exchange of a secret key between two distant parties, the emitter and the receiver, with a provable absolute security. An explanation of the method can be found in Nicolas Gisin, Gregoire Ribordy, Wolfgang Tittel, and Hugo Zbinden, “Quantum Cryptography”, Rev. of Mod. Phys. 74, (2002), the content of which is incorporated herein by reference thereto. One party—the emitter—encodes the value of each binary digit—or bit—of the key on a quantum system, such as a photon, by preparing this quantum system in a corresponding quantum state. A quantum system carrying a bit of the key is known as a qubit. The qubits are sent over a quantum channel, such as an optical fiber, to the other party—the receiver—which performs a quantum measurement to determine in which quantum state each qubit has been prepared. The results of these measurements are recorded and are used to produce the key. The security of this method comes from the well-known fact that the measurement of the quantum state of an unknown quantum system induces modifications of this system. This implies that a spy eavesdropping on the quantum channel cannot get information on the key without introducing errors in the key exchanged between the emitter and the receiver. In equivalent terms, QC is secure because of the no-cloning theorem of quantum mechanics: a spy cannot duplicate the transmitted quantum system and forward a perfect copy to the receiver.

Several QC protocols exist. These protocols describe how the bit values are encoded on quantum systems using sets of quantum states and how the emitter and the receiver cooperate to produce a secret key. The most commonly used of these protocols, which was also the first one to be invented, is known as the Bennett—Brassard 84 protocol (BB84), disclosed by Charles Bennett and Gilles Brassard in Proceedings IEEE Int. Conf. on Computers, Systems and Signal Processing, Bangalore, India (IEEE, New York, 1984), pp. 175-179, the content of which is incorporated herein by reference thereto. The emitter encodes each bit he wants to send on a two-level quantum system to prepare a qubit. Each qubit can be prepared either as an eigenstate of σₓ (|+x [symbol] coding for “0” and |−x [symbol] coding for “1”) or as an eigenstate of σ_{y} (|+y [symbol] or |−y [symbol] , with the same convention). One says that the bits are encoded in two incompatible bases. For each bit, the emitter uses an appropriate random number generator to generate two random bits of information, which are used to determine the bit value (one random bit) and the basis information (one random bit). Each qubit is sent across the quantum channel to the receiver, who analyses it in one of the two bases, i.e. measures either σₓ or σ_{y}. The receiver uses an appropriate random number generator to produce a random bit of information which determines the measurement basis (the basis information). The measurement basis is selected randomly for each qubit. After the exchange of a large number of quantum systems, the emitter and the receiver perform a procedure called basis reconciliation. The emitter announces to the receiver, over a conventional and public communication channel the basis x or y (eigenstate of σₓ or σ_{y}) in which each qubit was prepared. When the receiver has used the same basis as the emitter for his measurement, he knows that the bit value he has measured must be the one which was sent over by the emitter. He indicates publicly for which qubits this condition is fulfilled. The corresponding bits constitute the so-called raw key. Measurements for which the wrong basis was used are simply discarded. In the absence of a spy, the sequence of bits shared is error free. Although a spy who wants to get some information about the sequence of qubits that is being exchanged can choose between several attacks, the laws of quantum physics guarantee that he is not able to do so without introducing a noticeable perturbation in the key. The security of the BB84 protocol relies on the fact that the qubits sent by the emitter are prepared in quantum states belonging to incompatible bases. For a given qubit, it is, thus, not possible for an eavesdropper to determine its quantum state with absolute certainty. More generally, the BB84 protocol belongs to a class of protocols where at least two quantum states, in at least two incompatible bases, are used.

In practice, one has to use imperfect apparatuses, which implies that some errors are present in the bit sequence, even without interaction of the eavesdropper with the qubits. In order to still allow the production of a secret key, the basis reconciliation part of the protocol is complemented by other steps. This whole procedure is called key distillation. The emitter and the receiver check the perturbation level, also known as quantum bit error rate (QBER), on a random sample of the bit sequence in order to assess the secrecy of the transmission. Provided this error rate is not too large it does not prevent the distillation of a secure key, also known as the distilled key, from the raw key. The errors can indeed be corrected before the two parties apply a so-called privacy amplification algorithm that reduces the information amount that the eavesdropper could obtain to an arbitrarily low level.

Several other quantum cryptography protocols have been proposed. In 1992, Charles Bennett showed that it is sufficient to prepare the qubits in one of two non-orthogonal states and disclosed the so-called B92 protocol in Phys. Rev. Lett. 68, 3121 (1992), the content of which is incorporated herein by reference thereto. In this case, the emitter repeatedly sends qubits in one of two pure states |u₁> or |u₂>, which are non-orthogonal. It is not possible for the receiver to distinguish between them deterministically. The best he can perform is a generalized measurement (Optimal USD, to be more precise), also known as a positive operator value measurement, which some-times fails to give an answer, but at all other times gives the correct one (formally this measurement is a set of two projectors P₁=1−|u₂><u₂| and P₂=1−|u₁><u₁|). The results of this measurement on the qubits are used to generate bits of key. The fact that only two states are necessary means that this protocol is easier to implement in practice. It is nevertheless important to realize that an eavesdropper can also perform the generalized measurement. When he obtains an answer, he can forward a qubit prepared accordingly, while not doing anything when the result is inconclusive. This attack is particularly powerful in real apparatuses, where the receiver expects to detect only a small fraction of the qubits sent by the emitter, because of quantum channel attenuation and limited detector efficiency. When using mixed states ρ₁ and ρ₂ instead of pure states |u₁> or |u₂>, which is the case in practice, it is nevertheless possible to foil this attack by ensuring that the mixed states selected span two disjoint subspaces of Hilbert space. This allows the receiver to find two operators P₁ and P₂, such that P₁ annihilates ρ₂ and P₂ annihilates ρ₁, but no state is annihilated by both operators. This guarantees that if the eavesdropper sends a vacuum state instead of one of the mixed states ρ₁ and ρ₂, the receiver still registers conclusive measurement results, which introduce errors with a non-zero probability. When considering a large number of qubits, this non-zero probability produces a measurable error rate.

In the past decade, several demonstrations of QC apparatuses have been implemented using photons as the qubits and optical fibers as the quantum channel. For these implementations to be of practical use, it is important that they are simple and allow, if possible, high rate key exchange, in spite of current technological limitations. This consideration influences the choice of the QC apparatus and of the set of quantum states in which the qubits are prepared. In spite of the fact that polarization states of the electromagnetic field represent natural candidates for the implementation of QC, they are difficult to use in practice when optical fibers carry the qubits. Optical fibers indeed usually induce polarization state transformations. On the contrary, timing information is extremely stable and it can be used to implement simple QC apparatuses. Debuisschert et al. have proposed in Physical Review A 70, 042306 (2004), the content of which is incorporated herein by reference thereto, a family of time coding protocols. In the simplest of these protocols, the emitter sends for each bit a single-photon pulse. One of the bit values, say “0”, is coded by an undelayed pulse, while “1” is coded by a delayed pulse. The value of the delay is smaller than the pulse duration. The receiver measures the time of arrival of the photons with respect to a time reference and defines three sets of events. The first one contains detections that can only come from undelayed pulses and are counted as “0” value bits. The second set contains detections that can only come from delayed pulses and are counted as “1” value bits. Finally, the third set contains detections that can come from both the undelayed and the delayed pulses. They correspond to inconclusive results and are discarded. The receiver also sometimes sends the pulses into an interferometer to interferometrically measure their duration. The security of this protocol comes from the fact that whenever the eavesdropper obtains an inconclusive result, he must guess what state to forward to the receiver and has a non-zero probability of introducing errors. The interferometric measurement of the pulse duration prevents the eavesdropper from sending pulses much shorter than the original one to force the measurement result of the receiver.

While the original QC proposal called for the use of single photons as qubits to encode the key, their generation is difficult and good single-photon sources do not exist yet. Instead, most implementations have relied, because of simplicity considerations, on the exchange between the emitter and the receiver of weak coherent states, as approximations to the ideal qubits. A coherent state is said to be weak when its average number of photons per pulse is smaller than 1. Weak coherent states can be simply produced by attenuating laser pulses.

The fact that weak coherent states are used in practical implementations, instead of single photons, means that the eavesdropper can perform a very powerful attack, known as the Photon Number Splitting (PNS) attack (Norbert Lütkenhaus and Mika Jahma, New J. Phys. 4 44 (2002)). The eavesdropper performs a quantum non-demolition measurement to measure the number of photons present in each weak pulse. When a pulse contains exactly one photon, the eavesdropper blocks it. When a pulse contains two photons, the eavesdropper takes one photon and stores it in a quantum memory, while forwarding the other photon to the receiver. The eavesdropper finally measures the quantum states of the photons he has stored after the basis reconciliation step of the protocol. At this stage, the eavesdropper knows which measurement he must perform to obtain full information on the quantum state that had been sent by the emitter. In order to hide his presence, which could be revealed by a reduction of the detection rate of the receiver because of the blocked fraction of the pulses, the eavesdropper can make use of a perfect lossless channel—remember that in QC the eavesdropper is limited by physics but not technology—to forward to the receiver the multi-photon pulses from which he removed one photon. The PNS attack is particularly powerful in the real world, where the receiver expects to detect only a small fraction of the photons, because of quantum channel attenuation and limited detector efficiency. It is thus important to devise QC apparatuses and protocols that are resistant to these attacks.

Several approaches have been proposed to reduce the possibility for the eavesdropper to perform PNS attacks. Hwang W. Y. in Physical Review Letters 91, 057901 (2003), Wang X. B. in Physical Review Letters 94, 230503 (2005) and Lo H. K. et al. in Physical Review Letters 94, 230504 (2005), the contents of which are incorporated herein by reference thereto, have proposed to use Decoy states. Novel protocols resilient to PNS attacks have also been proposed. In H. Takesue et al, entitled “Differential phase shift quantum key distribution experiment over 105 km fibre”, quant-ph/0507110, the content of which is incorporated herein by reference thereto. Takesue et al. presented such a protocol using a binary (0, π) phase difference between two adjacent weak coherent states of duration t and separated by a time T in an infinite stream, with t smaller than T, to code the bit values. In this stream, adjacent weak coherent states are said to be phase coherent. The receiver performs an interferometric measurement to determine this differential phase and hence establish the bit value. The security of this protocol comes from the fact that the two quantum states corresponding to each differential phase value are non-orthogonal. An eavesdropper trying to measure bit values sometimes obtains inconclusive results. In these cases, he has to guess which state to forward and introduces errors with non-zero probability. If he elects instead not to forward anything to the receiver when he obtains an inconclusive result, he suppresses interference for the adjacent weak coherent state, which causes errors with non-zero probability. In this protocol, PNS attacks on individual weak coherent states are obviously useless as the bit value is coded in the phase difference between adjacent states. An effective PNS attack would have to measure the number of photons in two adjacent weak coherent states. This would however destroy the phase coherence with the other neighboring states and introduce errors with a non-zero probability.

Finally, another protocol which resists to photon number splitting attacks was suggested in 2004 by D. Stucki and coworkers (Applied Physics Letters 87, 194108 2005) In this protocol called “coherence one way” (COW) the logical bits are encoded in time. A sequence of weak coherent pulses is tailored from a CW-laser with an external intensity modulator.

The emitter, Alice, encodes bits using time slots (separated by T) containing either 0-pulses, no light (vacuum state), or μ-pulses, with a mean number of photons of μ<1. The logical bit “0” (“1”) corresponds to a sequence 0-μ (μ-0).

For security reasons, also μ-μ sequences, called decoy sequences have to be sent. The receiver, Bob, has a beam splitter which sends the pulses randomly to bit or the data channel and the monitoring channel. He registers the time-of-arrival of the photons on detectors D_{B} for the bit channel. The times D_{B} clicks, provide the raw key from which Alice and Bob can sift out the net key.

The security is guaranteed by checking the statistics for the detections in the monitoring channel. The photons are sent to an unbalanced interferometer that has a path length difference of T (pulse period) and detected at random times by the detector D_{M} situated at one output of the interferometer. The phase of the interferometer is set in a way that normally decoy and logical sequences “10” detected are not detected on D_{M} (destructive interference). If the eavesdropper tries to attack the bit exchange, his action will provoke detections on D_{M} at times that should not occur. The number of these clicks can be used to estimate the information of the eavesdropper.

### SUMMARY OF THE DISCLOSURE

It is an object of this disclosure to provide an apparatus and a method enabling users to exchange a sequence of symbols via a quantum channel. In particular, it is an object of the present disclosure to provide a system and a method for distributing a sequence of bits, e.g. a raw key, between an emitter station and a receiver station connected by a quantum channel, and enabling the stations to assess the secrecy of the sequence, e.g. an estimate of the maximum amount of information an eavesdropper can have obtained on the raw key which is subsequently to be distilled into a secure key. More particularly, it is an object of the present disclosure to provide such a system and method with an improved “coherence one way” (COW) protocol.

According to some embodiments of the present invention, a receiver station for receiving from an emitter station a sequence of symbols is configured to receive from the emitter station a stream of quantum systems through a quantum channel. Each of the quantum systems is generated by a quantum source of the emitter station and represents one of the symbols of the sequence. Each quantum system belongs to a set of at least two non-orthogonal quantum states and comprises a group of at least two weak coherent states of an electromagnetic field. Each weak coherent state is in a time bin of duration t. The centers of neighboring weak coherent states in a group are separated by a time T1, with T1 greater than t. The centers of neighboring weak coherent states in adjacent quantum systems are separated by a time T2, with T2 greater than t. In addition, any two weak coherent states separated by T1+T2 are phase coherent. For example, the exchanged sequence of symbols represents a raw encryption key which is used as the basis for producing a secure encryption key by applying a distillation method to the raw key.

The above-mentioned objects are particularly achieved in that the receiver station comprises an optical subsystem configured to check, for quantum systems received from the emitter station, phase coherence of two weak coherent states of time bins separated by T1+T2.

Changing the interval over which the coherence is checked (with respect to the original COW scheme where the imbalance is T=T1=T2) to T1+T2 (i.e. if T1=T2=T to 2T) has the advantage that the efficiency of the so-called unambiguous state discrimination (USD) attack is strongly reduced. This makes possible an increased secret key rate at longer distances and an extended reach of the secret key distribution.

In an embodiment, the optical subsystem comprises an optical device configured to optically superpose two weak coherent states of time bins separated by T1+T2 in such a way that they destructively interfere, if they are phase coherent. For example, the optical device comprises an interferometer having an optical path imbalance of T1+T2. For example, the interferometer is a Mach-Zehnder interferometer, a Michelson interferometer, or an auto-compensated interferometer comprising at least one Faraday mirror.

Setting the interferometer imbalance of the phase coherence measurement to twice the distance between adjacent time-bins has the advantage that the quantum systems need to be prepared only in two non-orthogonal states. There is no need for additional witness or decoy states which do not encode information but assure secrecy of the key. Thus, the amount of secure keys is increased since the whole stream of quantum systems can contribute to the secret key. Furthermore, no additional communication from the emitter is necessary to indicate whether or not a successfully discriminated quantum system can contribute to the raw key since all of them do. This drastically reduces the amount of classical communication needed for distilling secret keys from the raw key. Finally, during the second step of the method, more significant detections occur for the assessment of the information of the eavesdropper, which leads to better statistics and in the end to an increased secure key rate (finite key analysis).

In an embodiment, the optical subsystem further comprises at least one detector unit for determining a time of arrival of a photon with a resolution smaller than T1 and smaller than T2; and the optical device is configured to direct the superposed weak coherent states to the at least one detector unit.

For example, the at least one detector unit comprises an avalanche photodiode operated in gated Geiger mode, an avalanche photodiode operated in free-running Geiger mode, an optical frequency up conversion device connected via an optical path to another detector unit, and/or a superconducting single photon detector.

In a further embodiment, the receiver station further comprises a processing unit configured to transmit to the emitter station, via a conventional data communication channel, data about the phase coherence of two weak coherent states of time bins separated by T1+T2, for enabling the emitter station to determine a reduction of coherence between the quantum systems caused by an eavesdropper, and to assess the amount of information the eavesdropper having access to both channels could have obtained on the sequence

In an embodiment, the optical subsystem comprises at least two measurement subsystems and an intensity splitting device configured to distribute coherently, via optical paths, the quantum systems received from the emitter station to the at least two measurement subsystems. A first one of the measurement subsystems is configured to determine at least in some cases the quantum states in which the quantum systems were prepared by the emitter station. A second one of the measurement subsystems comprises an optical device for determining for adjacent quantum systems the phase coherence of two weak coherent states of time bins separated by T1+T2. In addition, the receiver station further comprises a processing unit configured to transmit to the emitter station, via a conventional data communication channel, data about the position in the stream of at least some of the quantum systems on which the first measurement subsystem yielded a measurement with conclusive results, and data about the phase coherence of two weak coherent states of time bins separated by T1+T2, for enabling the emitter station to determine a reduction of coherence between the quantum systems caused by an eavesdropper.

For example, the splitting device comprises an optical fiber coupler with a selected reflection/transmission ratio, or a beam splitter with a selected reflection/transmission ratio.

In an embodiment, the first measurement subsystem comprises a detector unit for determining a time of arrival of a photon with a resolution smaller than T1 and smaller than T2, the detector unit comprising an avalanche photodiode operated in gated Geiger mode, an avalanche photodiode operated in free-running Geiger mode, an optical frequency up conversion device connected via an optical path to another detector unit, or a superconducting single photon detector.

A method of distributing a sequence of symbols between an emitter station and a receiver station connected by a quantum channel, comprises receiving at the receiver station a sequence of quantum systems from the emitter station through a quantum channel. Each of the quantum systems is generated by a quantum source of the emitter station and represents one of the symbols of the sequence. Each quantum system belongs to a set of at least two non-orthogonal quantum states and comprises a group of at least two weak coherent states of an electromagnetic field. Each weak coherent state is in a time bin of duration t. The centers of neighboring weak coherent states in a group are separated by a time T1, with T1 greater than t. The centers of neighboring weak coherent states in adjacent quantum systems are separated by a time T2, with T2 greater than t. In addition, any two weak coherent states separated by T1+T2 are phase coherent.

The above-mentioned objects are particularly achieved in that the method further comprises checking by an optical subsystem of the receiver station, for quantum systems received from the emitter station, phase coherence of two weak coherent states of time bins separated by T1+T2.

In an embodiment, the checking of the phase coherence comprises superposing optically two weak coherent states of time bins separated by T1+T2 in such a way that they destructively interfere, if they are phase coherent.

In an embodiment, the method further comprises transmitting to the emitter station via a conventional data communication channel data about the phase coherence of two weak coherent states of time bins separated by T1+T2, for enabling the emitter station to determine a reduction of coherence between the quantum systems caused by an eavesdropper.

In an additional embodiment, the method further comprises producing a raw key from the stream of quantum systems received from the emitter station. Accordingly, by determining in the emitter station the reduction of coherence between the quantum systems caused by an eavesdropper, the emitter and the receiver are enabled to estimate the maximum amount of information an eavesdropper can have obtained on the raw key.

In yet another embodiment, the method further comprises producing a secure key from the raw key using a key distillation method.

This quantum cryptography communication system and method bear several further advantages, amongst others their simplicity and robustness, their security against so called photon-number splitting (PNS) attacks, and their independence of witness states and reduced classical communication expenses. Altogether they allow for increased secure key rates even with existing technology.

This quantum cryptography communication system and method for distributing a sequence of symbols between an emitter station and a receiver station have the further advantage, that they are robust and simple to implement, because of the fact that only linear optics is needed to prepare and measure the stream of quantum systems. The bit values are encoded by time coding on the quantum systems where one of the bit values is coded by preparing a quantum system consisting of a non-empty weak coherent state in a first of two time bins, while keeping the second time bin empty. The other bit value is encoded by preparing a quantum system with the empty and non-empty time bins being swapped. An optimal positive operator value measurement which allows distinguishing between these two states involves measuring the time of arrival of a photon with a single photon sensitive detector. This measurement is extremely simple to implement. Moreover, the quantum systems are extremely robust against environmental perturbation in the quantum channel. Polarization fluctuations for example do not induce errors.

Another advantage of this quantum cryptography communication system and method for distributing a sequence of symbols between an emitter station and a receiver station is their robustness against PNS attacks. Any two quantum systems sent by the emitter have a fixed phase relationship (they must be phase coherent). Eavesdropping is monitored by the receiver using an interferometric measurement of the phase coherence between two quantum systems. The robustness against PNS attacks stems from the fact that if an eavesdropper removes a quantum system and the receiver tries to measure the coherence of this particular quantum system with another one, the measurement outcome will indicate this removal with non-zero probability.

Neither the preceding summary nor the following detailed description purports to define or limit the invention. The invention is defined by the claims.

### BRIEF DESCRIPTION OF THE DRAWINGS

Specific embodiments of the present invention will be explained in more detail, by way of example, with reference to the drawings in which:

FIG. 1: shows a flow diagram illustrating an exemplary sequence of steps for distributing a stream of symbols between an emitter station and a receiver station connected by a quantum channel.

FIG. 2: shows a block diagram illustrating schematically quantum cryptography communication system including an emitter station and a receiver station interconnected by a quantum channel for distributing a stream of symbols.

FIG. 3: shows a sequence of symbols coded on a stream of quantum systems constituted by pairs of time-ordered coherent states.

FIG. 4: shows a block diagram illustrating schematically a quantum system source.

FIG. 5: shows a quadrature space for two time bins, whereby two quantum states corresponding to each of two values of quantum systems overlap and are thus non-orthogonal.

FIG. 6: shows a block diagram illustrating schematically an optical subsystem of a receiver, the optical subsystem having a splitting device which directs a stream of incoming quantum systems to two different measurement devices.

FIG. 7: shows interference time windows of different subsequences of quantum systems in cases with or without eavesdropper presence and activity.

### DETAILED DESCRIPTION OF THE PREFERRED EMBODIMENTS

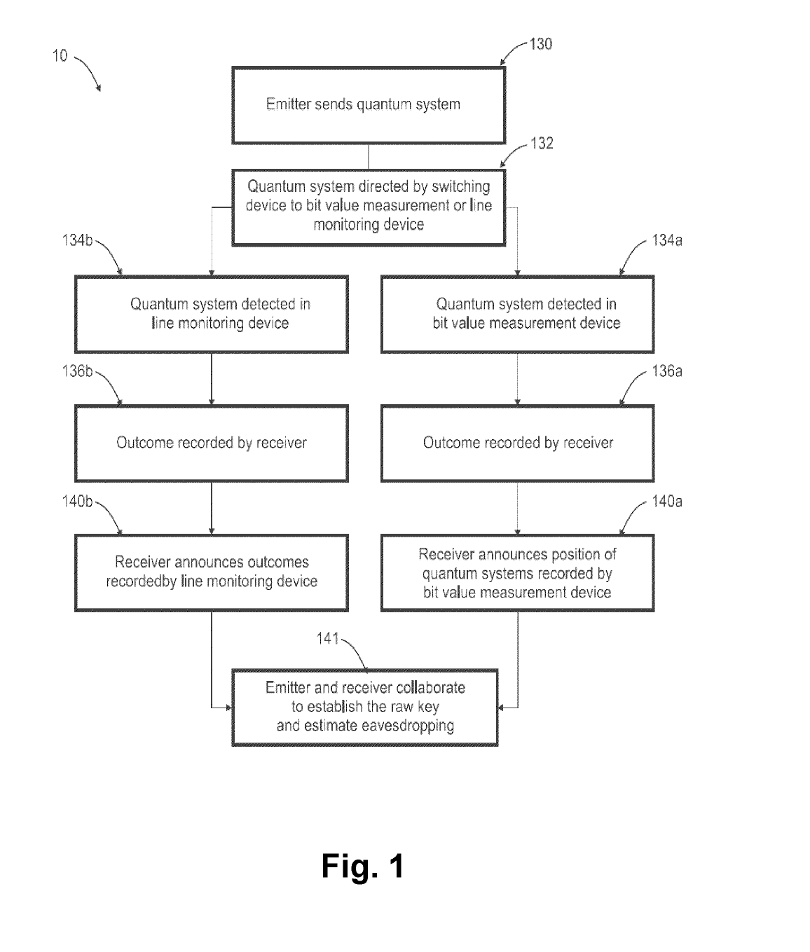

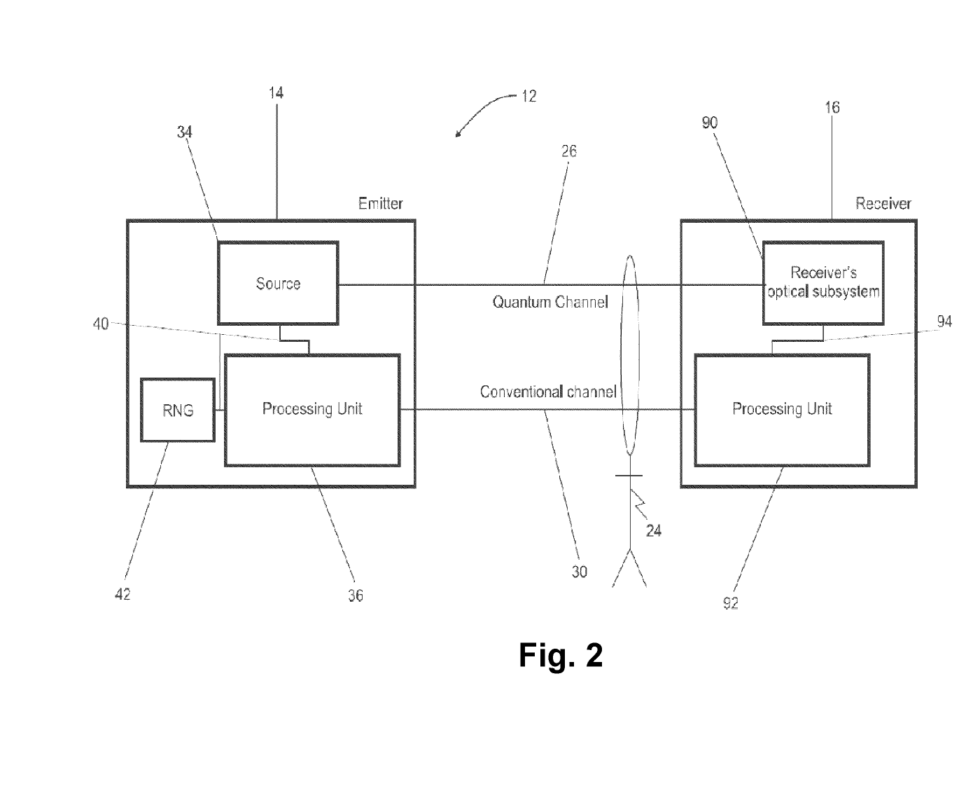

In FIG. 2, reference numeral 12 refers to a quantum cryptography communication system or apparatus for exchanging between an emitter station 14 and a receiver station 16 a sequence of symbols via a quantum channel 26, according to the method 10 illustrated in FIG. 1.

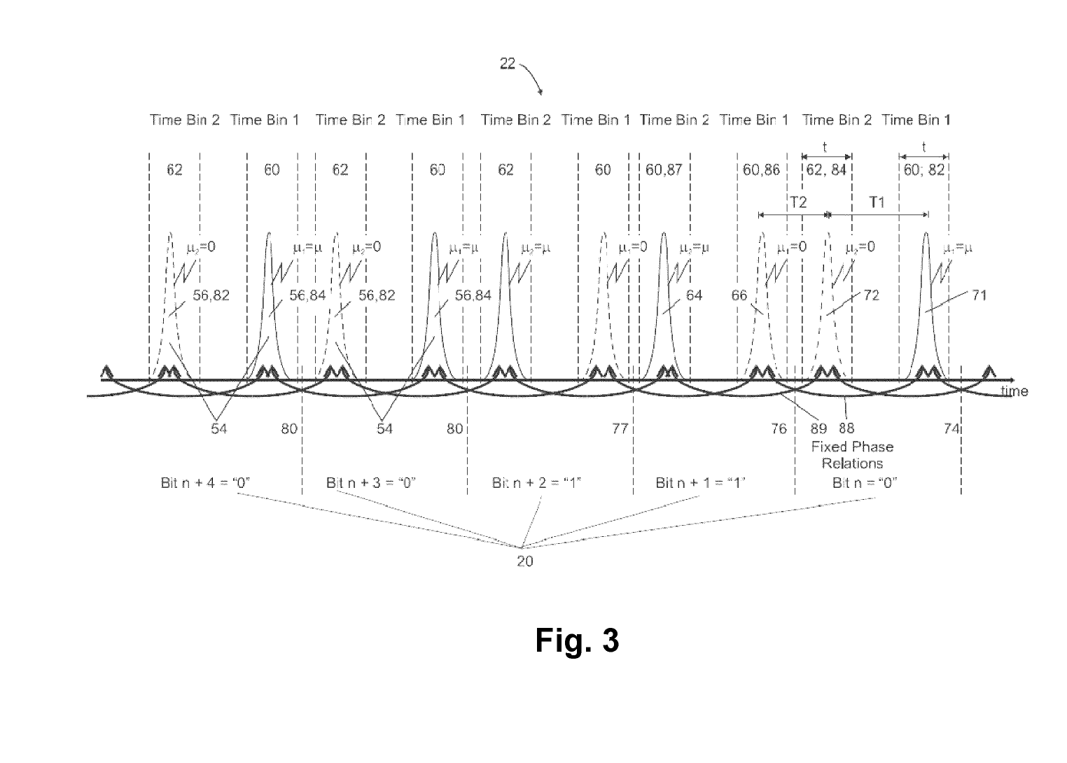

As illustrated in FIG. 3, the sequence of symbols are coded on a stream 22 of quantum systems 20, constituted by pairs of time-ordered coherent states, used to transmit the raw key (e.g. a data string such as 101100101001111001001010 . . . 01010100) and allowing the emitter station 14 and the receiver station 16 to estimate the maximum amount of information an eavesdropper 24 can have obtained on the raw key. This raw key can subsequently be distilled into a secure key (e.g. a distilled data string such as 10011000 . . . 1100 of fewer digits than the raw data string) through an appropriate key distillation procedure, known in the art.

As shown in FIG. 2, the emitter station 14 and the receiver station 16 are further connected by a conventional data communication channel 30, e.g. a conventional fixed or mobile data communication network, including a LAN or the Internet. The values of the symbols are encoded by preparing quantum systems in a particular quantum state.

The quantum states used to encode the bit values are not orthogonal. According to the laws of quantum physics it is hence impossible to determine the unknown quantum state with certainty. The best one can do is to perform a generalized measurement which gives unambiguous results with probability p<1 and ambiguous results with probability 1-p. Thus, the receiver station 16 can determine only a fraction of the states unambiguously—and, hence, also only a fraction of the symbols—sent by the emitter station 14.

The same holds for an eavesdropper 24 trying to gain information about the key. When obtaining an ambiguous result, an eavesdropper 24 has the choice to either prepare and forward a quantum system in a randomly selected state, or to block the quantum system. If an eavesdropper 24 decides to prepare and forward a random state 20, errors are inevitably introduced in the sequence of symbols which is obtained in the emitter station by measuring the stream of quantum systems 22. The emitter station 14 and the receiver station 16 can subsequently collaborate during a so-called key distillation phase to detect these errors.

The cases where an eavesdropper 24 decides to block quantum systems which yielded inconclusive results are indistinguishable from absorption by a lossy quantum channel 26. It is thus necessary to add a mechanism allowing the emitter and the receiver stations 14 and 16 to detect this kind of attack. To achieve this, the emitter station 14 ensures that a coherent phase relationship exists between any two adjacent quantum systems 20 of the stream 22. The receiver then verifies on randomly selected quantum systems that the coherent phase relationship between them was not altered by performing an interferometric measurement. Both, the removal of a quantum system 20 or the destruction of the phase relationship thus can be detected with non-zero probability.

However, the eavesdropper 24 still can perform another powerful attack which could allow gaining full information by coherently measuring the states of multiple quantum systems. This can be circumvented by setting the interferometer imbalance to match the distance between two bits (T1+T2 in FIG. 3) and by continuously monitoring a break of coherence between adjacent quantum systems.

In summary, the method 10 and apparatus 12 of the preferred embodiments are based on: first, the use of quantum systems 20 prepared in only two non-orthogonal states and featuring a coherent phase relationship with neighboring quantum systems; and second, the verification that the coherent phase relationship is conserved between adjacent quantum systems. An embodiment of the method 10 and apparatus 12 of the invention using time coding of the symbol values and using weak coherent states of the electromagnetic field in time bins is presented below.

Referring to FIG. 2, an embodiment of the apparatus 12 includes an emitter station 14 and a receiver station 16 connected by the quantum channel 26 and the conventional channel 30.

The quantum channel 26 can in principle be a free-space link. More convenient, however, are a dedicated optical fiber or a channel in a wavelength division multiplexing optical communication system. The conventional communication channel 30 can for example be realized via the internet, via an Ethernet connection or through a second optical fiber but must facilitate authenticated communication.

The emitter station 14 comprises essentially a quantum system source 34 and a random number generator 42, both controlled by a processing unit 36. The processing unit 36 comprises amongst others a memory, input/output ports, a central processor as well as a data transmission and communications mechanism permitting communications with other components of the apparatus. A random number generator 42 is connected to the processing unit 36 and serves as source for the stream of random bits which will be encoded onto the stream of quantum systems 22. The quantum system source 34 and the random number generator are connected to the processing unit 36 by transmission lines 40. The transmission lines 40 can for example be made up of wires or cables carrying electronic signals.

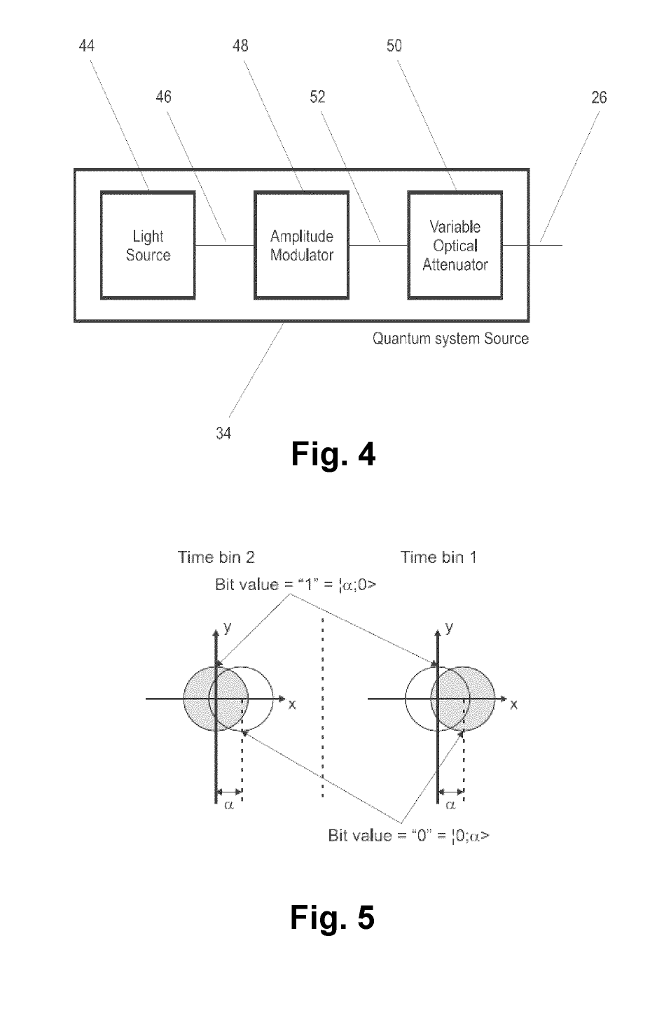

Referring now to FIG. 4, the quantum system source 34 includes a light source 44 connected by an appropriate optical path 46 to an optical amplitude modulator 48. The light source 44 can be realized for example by a mode-locked laser or a continuous wave laser. To adjust the overall amplitude of the quantum systems 20, the source 34 can also include a variable optical attenuator 50, connected to the amplitude modulator 46 by an optical path 52. The optical paths 46 and 52 can be for example optical fibers or free space optics links. The output of the quantum system source 34 is connected to the quantum channel 26 such that the stream of quantum systems 22 is launched into the quantum channel.

Referring again to FIG. 3, the source 34 produces a stream 22 of quantum systems 20. Each quantum system 20 is constituted by a pair 54 of time-ordered weak coherent states 56 of the electromagnetic field. Each weak coherent state 56 is centered in a time bin 60 and 62 of duration t. The centers of two adjacent time bins 60 and 62 are separated by a time T1, with t being smaller than T1. The separation between two quantum systems is T1+T2 with t smaller than T2. In principle, T1 need not to be equal to T2.

A quantum system carrying a “0” bit value 74 consists of a non-empty weak coherent state 71, containing on average μ photons in the first time bin 60 and a vacuum state 72 in the second time bin 62. Inversely, a quantum system carrying a “1” bit value 76 consists of a vacuum state 66 in the first time bin 60 and a non-empty weak coherent state 64 in the second time bin 62. The average number μ of photons in a non-empty weak coherent state is chosen to guarantee the security of the protocol.

Referring now to FIG. 5 which shows the quadrature space for the two time bins 60 and 62. The two quantum states corresponding to each of the two values of the quantum systems 20 overlap and are thus non-orthogonal, as required.

In a formal notation, a quantum system q can be written |q>=|β;α>. Each position in the “ket” on the right-hand side represents a mode. The states described above correspond to time coding where each mode is a non-overlapping time bin. The letters α and β indicate the complex amplitude of the coherent state in each of the time bins. In this notation, one can calculate the average number of photons in the first time by |α|² and in the second one by |β|². A quantum system carrying bit “0” is thus noted |0>=|0;α> and bit “1” is noted |1>=|α;0>. The average number of photons μ in the non-empty weak coherent state is equal to |α|².

An important property of the source 34 is that any two weak coherent states in the same time bin of adjacent bits, whether in the two time bins 60 and 86 or time bins 62 and 87 of neighboring quantum systems, have a fixed phase relationship. Equivalently, one can say that weak coherent states in adjacent bits, which are separated by T1+T2 in the stream 22 are phase coherent. Arrows 88 and 89 show the fixed phase relationships between two weak coherent states, e.g. 66 and 71, or 64 and 72. This implies that two such weak coherent states coherently interfere if superposed accordingly. A stream 22 of weak coherent states exhibiting such phase coherence can be produced by tailoring pulses out of a continuous wave laser beam with the amplitude modulator 48. Pulses produced by a mode-locked laser also exhibit this property.

For each quantum system 20 of the stream 22, the processing unit 36 of the emitter station 14 uses a random number provided by the random number generator 42 to select whether a “0”-quantum system or a “1”-quantum system should be sent over the quantum channel 26. For each quantum system 20, the processing unit 36 records the selection.

Referring now to FIG. 2, the receiver 16 includes an optical subsystem 90 and a processing unit 92. The processing unit 92 comprises, for example, a memory, input/output ports, a central processor managing inputs, memory and operating on such to produce desired outputs, as well as a data transmission and communications mechanism permitting communications with other components of the apparatus. The optical subsystem 90 is connected to the processing unit 92 by a transmission line 94. This transmission line 94 can for example include wires or cables carrying electronic signals.

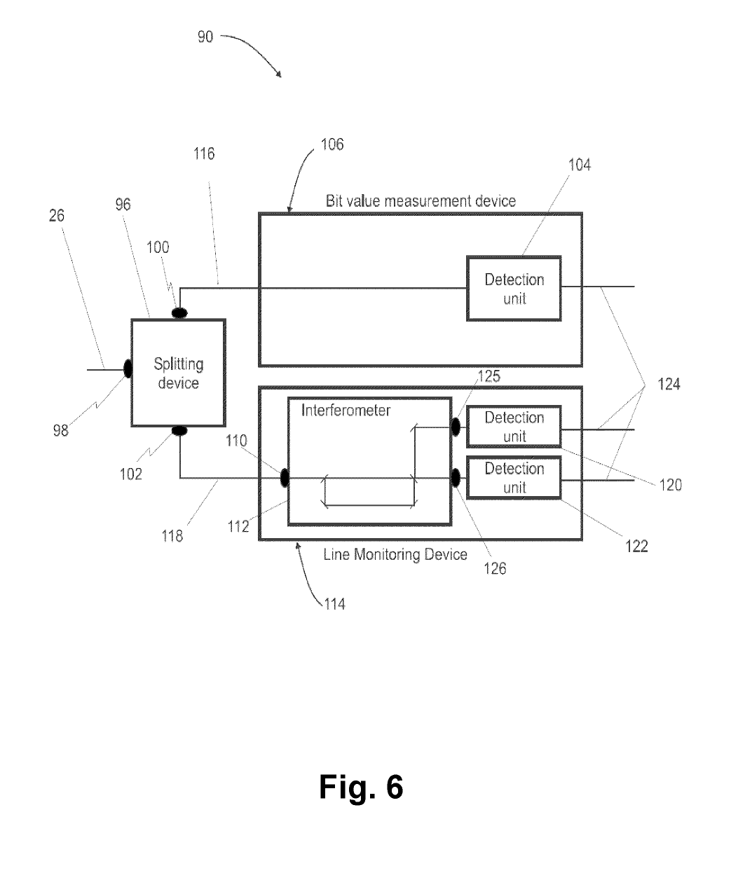

Referring now to FIG. 6, the receiver's optical subsystem 90 has a splitting device 96 with at least one input port 98 and at least two output ports 100 and 102. The splitting device 96 serves to direct the stream 22 of incoming quantum systems 20 to the bit value measurement device 106 or to the line monitoring device 114 via the optical paths 116 and 118. This splitting device 96 can for example be a fiber coupler or a beam splitter cube, both with appropriate reflection/transmission ratio. The input port 98 of the splitting device 96 is connected to the quantum channel 26. Its first output port 100 is connected via an optical path 116 to a detector unit 104 of a bit value measurement device 106, which measures the quantum states 20 in the time basis. The second output port 102 is connected via an optical path 118 to the input port 110 of an imbalanced interferometer 112 of a line monitoring device 114 which measures the optical coherence. Optical paths 116 and 118 can comprise for example optical fibers or free space optics paths.

The interferometer 112 can, for example, be an imbalanced Mach-Zehnder interferometer inducing a time delay of T1+T2 (i.e., if T1=T2=T, the time delay is 2T). It serves to superpose weak coherent states in the same time bin of adjacent bits. The imbalance of this interferometer 112 is adjusted to produce destructive interference in one of the output ports 125 or 126 and constructive interference in the other output port whenever two non-empty weak coherent states are present in time bins separated by the interferometer imbalance T1+T2 (or 2T, respectively). This is the case for sequences where two adjacent quantum states carry the same bit value.

Two detector units 120 and 122 are connected to the interferometer output ports 125 and 126. Detector units 104, 120, 122 can be for example single photon sensitive detectors with a timing resolution smaller than T1 and T2, sufficient to allow them to discriminate between the two time bins e.g., 60 or 62 of the quantum states 20 produced by the source 34. These single photon detectors 104, 120, 122 can for example include avalanche photodiodes in Geiger mode or free-running mode, devices exploiting a non-linear process to upconvert the incoming signal or devices registering a superconducting-normal phase transition. The detector units 104, 120, 122 are connected to the processing unit 92 by the transmission lines 124. These transmission lines 124 can for example be made up wires or cables carrying electronic signals.

The bit value measurement device 106 includes the detector unit 104 allowing distinction between the arrival of one photon in the first time bin 60 or the second one 62. This essentially amounts to performing a positive operator value measurement to distinguish between non-orthogonal states. As the average number of photons per quantum system 20 is low, the bit value measurement device 106 sometimes fails to record a detection in either of the time bins 60 or 62. When this happens, the measurement is inconclusive. When the detector unit 104 registers a detection, it is recorded by the processing unit 92.

The line monitoring device 114 enables monitoring of the degree of phase coherence between weak coherent states 66 and 71 in time bins 60 or 86 of two adjacent quantum systems 74 and 76 encoding each bit “0”, or between weak coherent states 64 and 72 in time bins 62 or 87 of two adjacent quantum systems 74 and 76 encoding each bit “1”. The two weak coherent states are superposed by the interferometer 112 and interferences recorded.

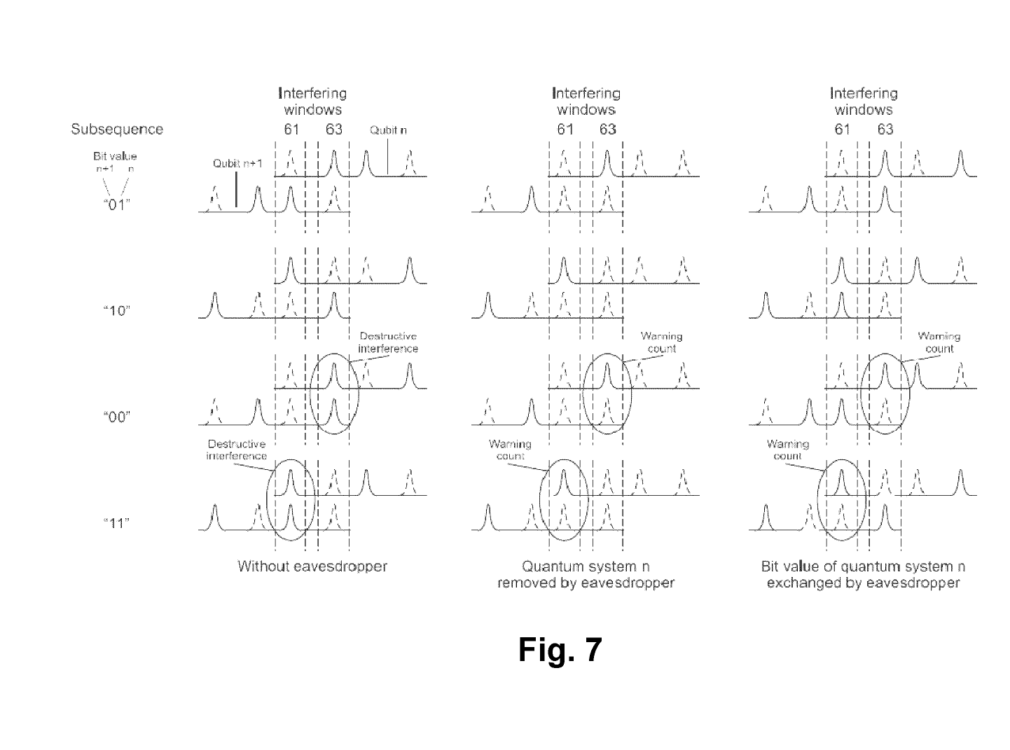

Referring now to FIG. 7, the left column, one can see that if the subsequence of quantum system values n and n+1 is “01” or “10”, the probability of recording a count in the interference time windows 61 and 63 is non-zero for both detector units 122 and 120. As a non-empty weak coherent state is superposed with an empty one, no interference occurs and the photon probabilistically chooses the output port 125 or 126 of the interferometer 112. If the subsequence is “00” then the detector units 122 and 120 should not record counts in the interference windows 61, because the two contributions are empty. In the interference window 63 the detector unit 122 should not record a count either because of destructive interference, while detector unit 120 has a non-zero probability of registering a count. If the subsequence is “11”, then the detector units 122 and 120 should not record counts in the interference window 63, because the two contributions are empty. In the interference window 61 the detector unit 122 should not record a count because of destructive interference, while detector unit 120 has a non-zero probability of registering a count.

Looking now at the center column, one can see that, in the case of a “00” or a “11” sequence and if the eavesdropper removes one of the quantum systems, it destroys interference. Detector unit 122 then records a count in one of the interference time windows with a non-zero probability. These counts are referred to below as the warning counts. This implies that an eavesdropper 24 who removes a quantum system 20, for example after obtaining an inconclusive result, induces a detectable perturbation. Obviously, if the eavesdropper 24 blocks all the quantum systems 20 in order to prevent the occurrence of these non-interfering events, he interrupts the communication, which will be noticed by the emitter and receiver.

Looking to the right column, one sees that the swap of one quantum system value will similarly induce counts in the interference time window, where none are expected. An eavesdropper 24, who would randomly guess unknown quantum systems values, would choose the wrong value with 50% probability. In these cases, he introduces warning counts with non-zero probability. Note that such an intervention by the eavesdropper 24 would also induce errors with non-zero probability in the sequence detected in the bit value measurement device 106.

Finally, a quantum non-demolition measurement across two weak coherent states, e.g. 71 and 72 belonging to a single quantum system, e.g. 74 destroys the phase coherence between weak coherent states of adjacent bits and will thus induce warning counts with non-zero probability, when one weak coherent state of the attacked quantum system is superposed with a weak coherent state of a neighboring quantum system. Similarly, a quantum non-demolition measurement on two weak coherent states, e.g., 66 and 72 belonging to two different quantum systems 76 and 74 destroys the phase coherence of both of these weak coherent states with the weak coherent state of their adjacent quantum systems, respectively. If a quantum non-demolition attack covers more than two weak coherent states, phase coherence will similarly be destroyed and warning counts induced. Detections of detector units 120 and 122 are recorded by the processing unit 92.

After the exchange of a large number of quantum systems 20, the receiver station 16 publicly announces over the conventional channel 30 in which cases he obtained a conclusive result in his bit value measurement device 106. The corresponding bit values are added to the raw key. The receiver station 16 also announces to the emitter station 14 over the conventional channel 30 in which cases he recorded detections in the detection units 120 and 122 of the line monitoring device 114. The emitter station 14 checks in the list of transmitted quantum systems 20 whether these detections were expected or whether not. The occurrence probability of warning counts allows the emitter station 14 and the receiver station 16 to deduce the intensity of the eavesdropping performed and thus the amount of information an eavesdropper 24 can have obtained on the key. This estimate allows them to adequately parameterize the post-processing procedures including, for example, error correction and privacy amplification, which produces the final secure key from the raw key.

In another embodiment of the apparatus 12, the emitter station 14 of the apparatus 12 is provided separately but for use with the receiver station 16 and vice-versa.

Referring again to FIG. 1, the key exchange method 10 of an embodiment of the invention includes the following steps.

In a first step 130, the emitter station 14 uses its quantum system source 34 to produce a quantum system 20 and send it through a quantum channel 26 to the receiver station 16.

In a second step 132, the quantum system 20 passes through the splitting device 96 (shown in FIG. 6), where it is either directed to the bit value measurement device 106 or to the line monitoring device 114, wherein associated measurements are performed on the stream of quantum systems.

In a first alternative substep 134a, for the quantum systems 20 directed by the splitting device 96 to the bit value measurement device 106, the time of arrival of the photons is measured. The outcomes of this measurement are recorded 136a by the processing unit 92 of the receiver station 16 and the position of the quantum systems for which the result was conclusive is announced 140a. These events constitute the raw key.

In a second alternative substep 134b, for quantum systems accordingly directed by the splitting device 96 to the line monitoring device 114 the phase coherence between time bins separated by T1+T2 (or 2T, respectively) is interferometrically measured. The outcomes of this second measurement are recorded by the processing unit 92 of the receiver station 16 and the measurement outcomes are announced 140b.

In a subsequent step 141 the emitter station 14 and the receiver station 16 exchange relevant information to assess the intensity of eavesdropping during the exchange by estimating the degree of phase coherence from the outcome of the measurements of step 134b.

A raw key as well as an estimate of the information that an eavesdropper can have obtained on this raw key constitute the products of the key exchange method 10.

As an advantage, this quantum cryptography apparatus 12 and method 10 is simple to implement. This simplicity stems from the fact that the quantum systems 20 need to be prepared in only two non-orthogonal states by using solely linear optics.

As another advantage, the apparatus 12 and method 10 allows the use of time coding of the values of the quantum systems 20. One of the bit values is coded by preparing a quantum system, e.g., 74 consisting of a non-empty weak coherent state 71 in a first of two time bins 60, while keeping the second time bin 62 empty, with each time bin being shorter than the time between them. The other bit values are coded on a quantum system, e.g., 76 where the empty and non-empty time bins are swapped. In this case, one of the optimal positive operator value measurements allowing one to distinguish between the two states involves measuring the time of arrival of a photon with a photon counting detector. This measurement is extremely simple to perform.

As another advantage, the states used are moreover extremely robust against environmental perturbation in the quantum channel 26. Polarization fluctuations for example do not induce errors.

As another advantage, the simplicity of the process enables a high rate key exchange to be achieved, even with existing technology.

Another advantage of this quantum cryptography apparatus 12 and method 10 is that they are robust against eavesdropping, which is monitored by an interferometric measurement of the phase coherence between two quantum systems e.g., 60 and 86, or 62 and 87 using an interferometer with imbalance T1+T2 (or 2T, respectively). In particular, this apparatus 12 and method 10 are very robust against PNS attacks. This attribute stems from the fact that removal of quantum systems 20 by an eavesdropper 24 results in a noticeable perturbation. If one of the quantum systems 20 is removed and the receiver station 16 tries to measure the coherence of this particular quantum system with another one, the measurement outcome will indicate this removal with a non-zero probability.

Multiple variations and modifications are possible in the embodiments described herein. Although certain illustrative embodiments of the invention have been shown and described here, a wide range of modifications, changes, and substitutions is contemplated in the foregoing disclosure. In some instances, some features may be employed without a corresponding use of the other features. Accordingly, it is appropriate that the foregoing description be construed broadly and understood as being given by way of illustration and example only, the spirit and scope of the invention being limited only by the claims.

1. A receiver station for receiving from an emitter station a sequence of symbols, the receiver station configured to receive from the emitter station a stream of quantum systems through a quantum channel, each of the quantum systems being generated by a quantum source of the emitter station and representing one of the symbols of the sequence, each quantum system belonging to a set of at least two non-orthogonal quantum states and comprising a group of at least two weak coherent states of an electromagnetic field, each weak coherent state being in a time bin of duration t, centers of neighboring weak coherent states in a group being separated by a time T1, with T1 greater than t, centers of neighboring weak coherent states in adjacent quantum systems being separated by a time T2, with T2 greater than t, and any two weak coherent states separated by T1+T2 being phase coherent, wherein the receiver station comprises an optical subsystem configured to check, for quantum systems received from the emitter station, phase coherence of two weak coherent states of time bins separated by T1+T2.

2. The receiver station of claim 1, wherein the optical subsystem comprises an optical device configured to optically superpose two weak coherent states of time bins separated by T1+T2 in such a way that they destructively interfere, if they are phase coherent.

3. The receiver station of claim 2, wherein the optical subsystem further comprises at least one detector unit for determining a time of arrival of a photon with a resolution smaller than T1 and smaller than T2; and the optical device is configured to direct the superposed weak coherent states to the at least one detector unit.

4. The receiver station of claim 3, wherein the at least one detector unit comprises one of: an avalanche photodiode operated in gated Geiger mode, an avalanche photodiode operated in free-running Geiger mode, an optical frequency up conversion device connected via an optical path to another detector unit, and a superconducting single photon detector.

5. The receiver station of claim 2, wherein the optical device comprises an interferometer having an optical path imbalance of T1+T2.

6. The receiver station of claim 5, wherein the interferometer is one of: a Mach-Zehnder interferometer, a Michelson interferometer, and an auto-compensated interferometer comprising at least one Faraday mirror.

7. The receiver station of claim 1, further comprising a processing unit configured to transmit to the emitter station, via a conventional data communication channel, data about the phase coherence of two weak coherent states of time bins separated by T1+T2, for enabling the emitter station to determine a reduction of coherence between the quantum systems caused by an eavesdropper, and to assess the amount of information the eavesdropper having access to both channels could have obtained on the sequence.

8. The receiver station of claim 1, wherein the optical subsystem comprises at least two measurement subsystems and an intensity splitting device configured to distribute coherently, via optical paths, the quantum systems received from the emitter station to the at least two measurement subsystems, a first measurement subsystem configured to determine at least in some cases the quantum states in which the quantum systems were prepared by the emitter station, and a second measurement subsystem comprising an optical device for determining for adjacent quantum systems the phase coherence of two weak coherent states of time bins separated by T1+T2; and the receiver station further comprises a processing unit configured to transmit to the emitter station, via a conventional data communication channel, data about the position in the stream of at least some of the quantum systems on which the first measurement subsystem yielded a measurement with conclusive results, and data about the phase coherence of two weak coherent states of time bins separated by T1+T2, for enabling the emitter station to determine a reduction of coherence between the quantum systems caused by an eavesdropper.

9. The receiver station of claim 8, wherein the splitting device comprises one of: an optical fiber coupler with a selected reflection/transmission ratio, and a beam splitter with a selected reflection/transmission ratio.

10. The receiver station of claim 8, wherein the first measurement subsystem comprises a detector unit for determining a time of arrival of a photon with a resolution smaller than T1 and smaller than T2, the detector unit comprising one of: an avalanche photodiode operated in gated Geiger mode, an avalanche photodiode operated in free-running Geiger mode, an optical frequency up conversion device connected via an optical path to another detector unit, and a superconducting single photon detector.

11. A method of distributing a sequence of symbols between an emitter station and a receiver station connected by a quantum channel, the method comprising:
receiving at the receiver station a stream of quantum systems from the emitter station through a quantum channel, each of the quantum systems being generated by a quantum source of the emitter station and representing one of the symbols of the sequence, each quantum system belonging to a set of at least two non-orthogonal quantum states and comprising a group of at least two weak coherent states of an electromagnetic field, each weak coherent state being in a time bin of duration t, centers of neighboring weak coherent states in a group being separated by a time T1, with T1 greater than t, centers of neighboring weak coherent states in adjacent quantum systems being separated by a time T2, with T2 greater than t, and any two weak coherent states separated by T1+T2 being phase coherent; and
checking by an optical subsystem of the receiver station, for quantum systems received from the emitter station, phase coherence of two weak coherent states of time bins separated by T1+T2.

12. The method of claim 11, wherein the checking of the phase coherence comprises superposing optically two weak coherent states of time bins separated by T1+T2 in such a way that they destructively interfere, if they are phase coherent.

13. The method of claim 11, further comprising transmitting to the emitter station via a conventional data communication channel data about the phase coherence of two weak coherent states of time bins separated by T1+T2, for enabling the emitter station to determine a reduction of coherence between the quantum systems caused by an eavesdropper.

14. The method of claim 11, further comprising producing a raw key from the stream of quantum systems received from the emitter station.

15. The method of claim 14, further comprising producing a secure key from the raw key using a key distillation method.
